(19) United States
(12) Patent Application Publication
(10) Pub. No.: US 2018/0254819 A1
(43) Pub. Date: Sep. 6, 2018

(54) WIRELESS ELECTROMAGNETIC COMMUNICATION NETWORK USING POLARIZATION DIVERSITY

(71) Applicant: JERUSALEM COLLEGE OF TECHNOLOGY, Jerusalem (IL)

(72) Inventors: Philippe Ezran, Jerusalem (IL); Yoram Haddad, Beth El (IL)

(21) Appl. No.: 15/528,569

(22) PCT Filed: Nov. 23, 2015
(86) PCT No.: PCT/IL2015/051131

§ 371 Date: May 22, 2017

Related U.S. Application Data
(60) Provisional application No. 62/083,240, filed on Nov. 23, 2014.

(51) Int. Cl. H04B 7/10; H04B 7/26; H04W 16/18

(52) U.S. Cl. CPC H04B 7/10; H04W 16/18; H04B 7/2606

(57) ABSTRACT

A central system is presented for managing operation of a plurality of electromagnetic transceiver stations, forming a wireless electromagnetic closed loop communication network, to enable single-channel communication between the transceiver stations in the closed loop topology network. The central system comprises a data processor utility which is adapted to receive and process data indicative of an arrangement map of the plurality of the electromagnetic transceiver stations and generate data indicative of a polarization map for the communication network for communication between the transceiver stations using a single frequency channel. The said data indicative of the arrangement map comprises at least location data comprising locations of the stations defining at least one closed loop topology. The polarization map comprises data indicative of assigned polarization states for transmission between each two neighboring stations along the closed loop network.

### TECHNOLOGICAL FIELD AND BACKGROUND

The present invention is generally in the field of wireless communication, and relates to wireless communication network utilizing polarization diversity.

It is generally known that, besides signal frequency, the state of polarization of the signals creates different communication channels for the communication network.

Wireless communication network may typically be of point-point, point-to-multiple-point or multiple-point-to-multiple-point type. The topology of point-point network is a disconnected set of linear links; the topology of a point-to-multiple-point network is a ‘star’ or ‘hub and spoke’. Generally speaking, a number of different topologies (driven somewhat by the technology, and somewhat by the geography of the area in which the network existed), have been developed, including ring networks, both open and closed, and mesh networks.

Typically, data channels concurrently transmitted through the network are distinguished from one another by frequencies. Polarization diversity has recently gained interest as another mean to meet the growing demand for wireless spectrum. Since conventional networks used only vertical polarization, polarization diversity was achieved by adding a horizontal polarization.

### GENERAL DESCRIPTION

The present invention provides a novel data/signal communication technique for use in an electromagnetic communication network of a closed loop (termed “ring”) topology. The invention utilizes the principles of polarization diversity in order to increase spectrum efficiency.

Polarization diversity enables to reuse the same frequency in a network. In order to avoid interferences, the two polarizations received by a base station at the same frequency must be orthogonal to each other. More specifically, in an electromagnetic wave, electric field and magnetic field are oscillating in two directions orthogonal to the propagation direction and orthogonal to each other. If the fields rotate at the optical frequency, the polarization is circular or elliptic. If the fields oscillate in one single direction, the polarization is linear. By convention, the direction of a linear polarization is the direction of the electric field.

The ring topology network is formed by a chain of points (transceiver nodes) where each node communicates with (receives and transmits data from) its two opposite neighboring nodes, and thus the “last” node of the chain transmits data to the “first” node of said chain. The invention is based on the inventors understanding of the following:

Considering polarization diversity for distinguishing between the data streams of the same channel (i.e. frequency) passing through network, in a chain comprising the nodes A, B and C, the polarization \vec{E_{AB}} between A and B may be chosen arbitrarily (upon the condition it is orthogonal to the line AB, i.e. to the propagation path between points A and B), but then, the polarization \vec{E_{BC}} between B and C shall be orthogonal to \vec{E_{AB}}. Since \vec{E_{BC}} shall also be orthogonal to the line/path BC (the propagation path between points B and C), the direction of \vec{E_{AB}} generally determines that of \vec{E_{BC}}. This method can be generalized to any number of nodes, and therefore polarization diversity can be achieved in any open-loop network. The case is more complicated when the network is a closed-loop network (known as “ring topology network”): there is no certitude that the last polarization will be orthogonal to the first one.

In the case of a closed loop topology when the stations are arranged in the same plane, a distinction could be made whether the number of the stations is odd or even. If the number of stations is even, i.e. the number of transmissions between the stations is even, then the usage of alternating horizontal and vertical polarizations should generally be sufficient. On the other hand, if the number of stations is odd, i.e. the number of transmissions between the stations is odd, then the usage of alternating horizontal and vertical polarizations is not sufficient, because it will always be a pair of neighboring stations (first and last stations) unavoidably resulting with the same polarization.

The inventors have found that data indicative of an arrangement map of a plurality of electromagnetic transceiver stations in a wireless electromagnetic communication network of a closed loop topology can be analyzed and processed to assign polarization states (polarization vectors) for each transceiver operation enabling single-channel communication between each two neighboring stations along the closed loop. The arrangement map characterizes a given closed loop topology defined by the locations of the stations and the order in which they communicate with one another (defining the unit vectors of lines connecting each two neighboring stations, i.e. direction of propagation along the closed loop) for the given topology.

As will be described further below, the data indicative of the arrangement map may comprise the arrangement map itself (locations of the transceiver stations and the order in which the stations are to communicate with one another), or may include only the location of the stations. In the latter case, the arrangement map is properly determined. Moreover, as also will be described below, the arrangement map can vary (by varying the unit vectors) to determine the optimal closed loop topology for the given number and locations of the transceiver stations, to enable the single-channel operation of the network with polarization diversity.

Thus, the expression “data indicative of arrangement map” refers to data comprising at least location data about locations of the transceiver stations defining at least one closed loop topology, or may also include data about an order in which the stations are to communicate with one another defining a certain (given) closed loop topology thus enabling to use the location and order data and determine the unit vectors.

The transceiver station typically includes two transceivers for communication with, respectively, two opposite neighboring stations according to the closed loop topology. The data analysis is based on an orthogonal polarization condition, such that the polarization vector for transmission between each one of the stations and its neighboring station is orthogonal to the polarization vector for transmission between said neighboring station and a successive neighboring station and is orthogonal to the unit vector of direction of propagation between said one of the stations and said neighboring station.

More specifically, the arrangement map data is analyzed to identify, for each station, the unit vector indicative of direction to its neighboring station along the closed loop topology. Then, an endomorphism relation is determined, based on the orthogonal polarization condition and the unit vectors of each of the stations with respect to the neighboring stations along the closed loop topology starting from an arbitrarily selected first one of the stations. The endomorphism relation is processed to determine a corresponding eigenvector indicative of a first polarization vector for signal transmission between the selected first station and its neighboring station along the closed loop topology. The first polarization vector and the orthogonal polarization condition are used for successively determining polarization vector for each of the stations. These polarization vectors for all the stations present together a polarization map for the single-channel communication between the stations in said closed loop network.

In some embodiments, the analyzer is adapted for generating a control signal upon identifying that the eigenvector cannot be determined for the endomorphism relation.

In some embodiments, the analyzer, upon identifying that the eigenvector cannot be determined for the endomorphism relation, is adapted for modifying the arrangement map data by varying the unit vectors thereby modifying the closed loop topology, and repeating the above analyzing and processing steps for each of the modified closed loop topologies to determine the “first” polarization vector. Similarly, the analyzer may be adapted for generating a control signal upon identifying that the eigenvector cannot be determined for the endomorphism relation.

In some embodiments, the analyzer utilizes the location data and directionality of operation of the transceiver stations to determine one or more possible closed loop topologies satisfying signal to noise requirements for the network operation.

Thus, according to one broad aspect of the invention, there is provided central system for managing operation of a plurality of electromagnetic transceiver stations forming a wireless electromagnetic closed loop communication network, the central system comprising:

data processor utility which is adapted to receive and process data indicative of an arrangement map of said plurality of the electromagnetic transceiver stations and generate data indicative of a polarization map for said communication network for communication between said transceiver stations using a single frequency channel, said data indicative of the arrangement map comprising at least location data comprising locations of the stations defining at least one closed loop topology, the polarization map comprising data indicative of assigned polarization states for transmission between each two neighboring stations along said closed loop.

According to another broad aspect of the invention, it provides a communication network for wireless communication between a plurality of transceiver stations in a closed loop topology, wherein each of the transceiver stations comprises a pair of transceivers for directional communication with two transceivers at opposite neighboring transceiver stations in the closed loop topology. The network comprises the above-described central system adapted to determine polarization vectors for the pair of transceivers for each of the transceiver stations to allow a single-channel communication between the transceiver stations with polarization diversity using said polarization vectors.

In such network, each of the transceiver stations preferably includes a polarization utility adapted to controllably modify the polarization vectors of signals transceived by each transceiver of the pair of transceivers, in response to control data indicative of the polarization vectors as received from the central system.

According to yet further aspect of the invention, there is provided an electromagnetic transceiver station configured for communication with its opposite neighboring electromagnetic transceiver stations in a communication network having a closed loop topology. The electromagnetic transceiver station comprises two transceivers for communication with the opposite neighboring electromagnetic transceiver stations, respectively, and a polarization utility adapted to controllably modify polarization vectors of signals transceived by each of the two transceivers in accordance with polarization states assigned for these transceivers for signal-channel communication with the two neighboring stations.

The present invention also provides a method for managing operation of a plurality of electromagnetic transceiver stations in a wireless electromagnetic communication network of a closed loop topology. The method comprises: providing data indicative of an arrangement map of said plurality of the electromagnetic transceiver stations, wherein said data indicative of the arrangement map comprises at least location data indicative of locations of the stations defining at least one closed loop topology; and processing said data indicative of the arrangement map and generating a polarization map for communication between said stations using a single frequency channel, the polarization map comprising data indicative of assigned polarization states for transmission between each two neighboring stations along said closed loop, thereby providing single-channel communication between the transceiver stations in the closed loop topology network.

The processing for generating the polarization map comprises determining the polarization vectors satisfying the orthogonal polarization condition, as described above.

The provision of the data indicative of the arrangement map may comprise analyzing the location data and an order in which the stations are to communicate with one another along the at least one closed loop topology, and determining the unit vectors for the at least one closed loop topology

The processing of the arrangement map data may comprise the following: (i) for each station, utilizing the unit vector indicative of the direction to its neighboring station along said at least one closed loop topology, and determining an endomorphism relation based on the orthogonal polarization condition and the unit vectors of each of the stations with respect to the neighboring stations along said closed loop topology starting from an arbitrarily selected first one of the stations; and (ii) processing the endomorphism relation to determine a corresponding eigenvector indicative of a first polarization vector for signal transmission between said selected first station and its neighboring station along the loop.

The generation of the polarization map comprises utilizing the first polarization vector and successively determining polarization vector for each of the stations.

The processing of the arrangement map data may comprise generation of a control signal upon identifying that the endomorphism has no eigenvector. In some embodiments, the processing of the arrangement map data comprises modifying the arrangement map data upon identifying that the endomorphism has no eigenvector. The modification of the arrangement map data includes modifying the closed loop topology, and repeating the above steps (i) and (ii) for each of the modified closed loop topologies. Upon identifying that the eigenvector cannot be determined for the endomorphism relation, the control signal indicative thereof may be generated.

As also described above, the location data and directionality of operation of the transceiver stations can be utilized for determining one or more possible closed loop topologies satisfying signal to noise requirements for the network operation.

### BRIEF DESCRIPTION OF THE DRAWINGS

In order to better understand the subject matter that is disclosed herein and to exemplify how it may be carried out in practice, embodiments will now be described, by way of non-limiting examples only, with reference to the accompanying drawings, in which:

FIG. 1 is a block diagram of a central system configured and operable according to the invention for managing single-channel communication between multiple transceiver stations in a communication network of a closed loop topology;

FIG. 2 is a block diagram of an example of a transceiver station suitable for use in a closed loop topology network;

FIG. 3 schematically exemplifies an arrangement of n points in a closed loop topology communication network;

FIG. 4 exemplifies two orthogonal bases of the space which will be used to find the appropriate polarizations;

FIG. 5 exemplifies a flow diagram of a method according to the invention for managing operation of a closed loop communication network; and

FIGS. 6 and 7 exemplify the closed loop topologies for a communication network.

### DETAILED DESCRIPTION OF EMBODIMENTS

The present invention provides a novel technique aimed at managing single-channel communication (transmission of different data streams of the same frequency) through an electromagnetic communication network of a closed loop topology. As described above, in order to transmit a signal having a specific frequency through a closed loop (ring topology) of stations/points, the polarization state of the each transceiver station in the loop should be orthogonal to that of the neighboring transceiver station. The polarization state of the first transceiver determines the polarization state of the second one, which determines the polarization state of the third one and so forth until the last transceiver in the closed loop network.

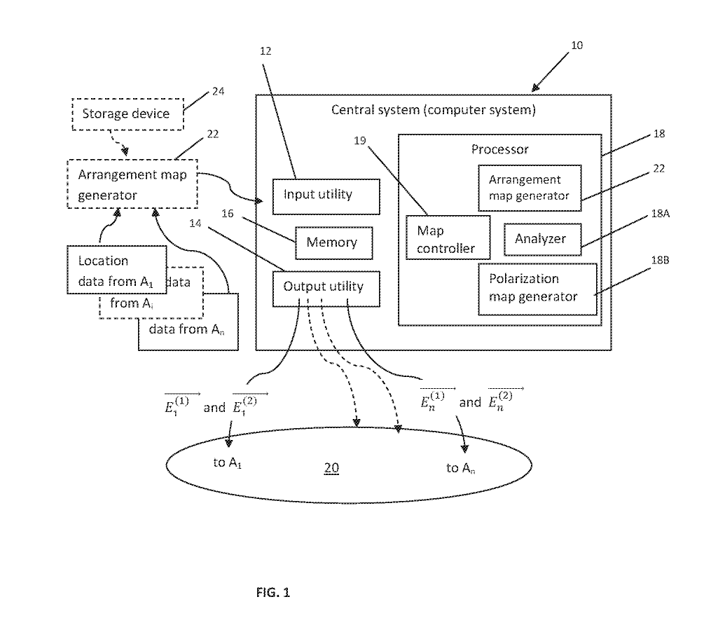

Reference is made to FIG. 1 schematically illustrating, by way of a block diagram, a central system 10 configured and operable according to the invention for managing operation of a plurality of N electromagnetic transceiver stations A₁, A₂, . . . Aₙ (e.g. antenna units) forming a wireless electromagnetic communication network 20 of one or more possible closed loop topologies. The transceiver station Aᵢ constitutes a point/node of the network 20.

It should be noted, and will be described more specifically further below, that the possible closed loop topology (i.e. operative closed loop topology) for a wireless electromagnetic communication network formed by a given number of transceiver stations is defined by locations of the transceiver stations and an order in which these stations can communicate with one another. More specifically, in a closed loop network, each such station is to communicate with a preceding station and a successive station, which in turn is defined by directionality of transceivers and signal-to-noise requirement/limitation. Hence, the enabled variation of communication orders defines possible sequences of the stations, presenting possible closed loop topologies of the network.

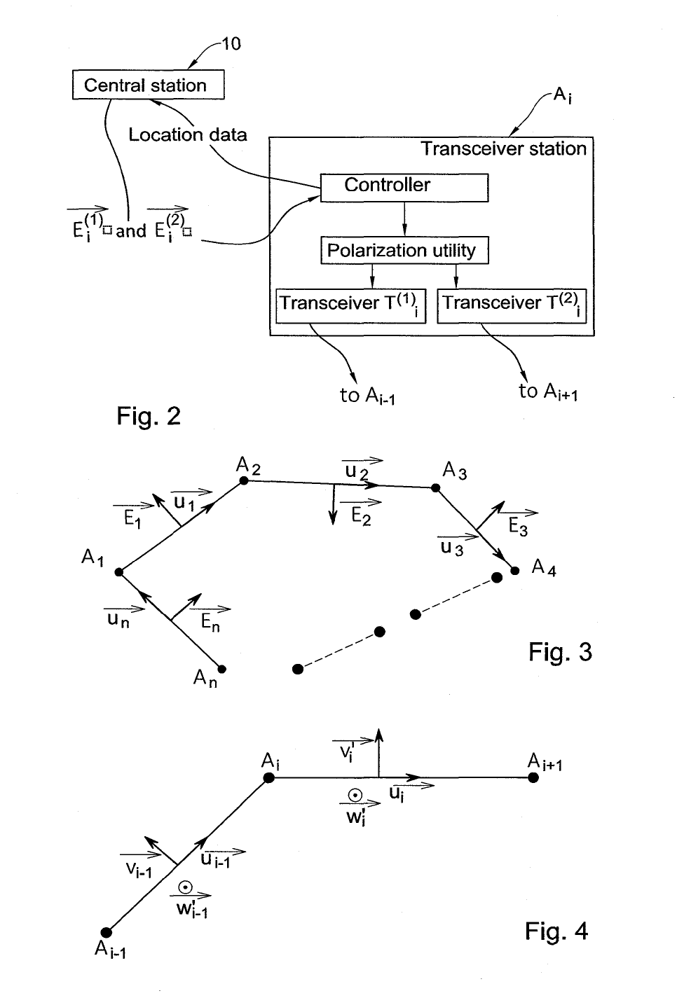

As schematically illustrated in FIG. 2, for the purposes of this invention, each transceiver station Aᵢ includes a pair of transceivers T⁽¹⁾ᵢ and T⁽²⁾ᵢ associated with respective directional signaling units (such as antennas) for communication with, respectively, two “neighboring” transceiver stations. Aᵢ₋₁ and Aᵢ₊₁. More specifically, transceiver T⁽¹⁾ᵢ transmits signals to and receives signals from a respective transceiver (T⁽²⁾ᵢ₋₁) of station Aᵢ₋₁ and transceiver T⁽²⁾ᵢ transmits signals to and receives signals from a respective transceiver (T⁽¹⁾ᵢ₊₁) of station Aᵢ₊₁. Also provided in the transceiver station Aᵢ is a controller 15 for communication with the central system 10.

Turning back to FIG. 1, the central system 10 is typically a computer system operable as a server system, in the meaning that it is in data communication with multiple transceiver stations via a network. The central system 10 includes inter alia such main functional modules/utilities (software and/or hardware modules) as data input and output utilities 12 and 14, memory 16, and data processor 18. The data input and output utilities are typically connected to an appropriate communication port for data communication via a computer network.

The input utility 12 operates for receiving input data indicative of an arrangement map of a plurality of the electromagnetic transceiver stations A₁, A₂, . . . Aₙ in the closed loop communication network 20. The received input data may include the arrangement map itself provided for example from a storage device 24 (e.g. external storage), or provided by an external arrangement map generator 22. Alternatively, or additionally, the received input data may include location data from each of the transceiver stations A₁, A₂, . . . , Aₙ defining a closed loop topology, which is analyzed at the computer system 10 (its integral arrangement map generator module 22) to generate the arrangement map for the closed loop network 20.

The arrangement map data includes a number n of transceiver stations A₁, . . . Aₙ in the closed loop network and data indicative of propagation paths between each two neighboring stations, i.e. order in which the stations are to communicate with one another. As will be described further below, this data is used to determine data indicative of unit vectors of lines connecting each two neighboring stations according to the closed loop topology. The arrangement map data may be stored in the memory 16.

The data processor utility 18 is adapted (preprogrammed) to process the arrangement map data and generate output data indicative of a polarization map for single-channel communication between the n stations. The polarization map includes data indicative of polarization vectors/states \vec{E_{ι}⁽¹⁾} and \vec{E_{ι}⁽²⁾} assigned to transceivers T⁽¹⁾ᵢ and T⁽²⁾ᵢ of each station Aᵢ for communication with its two opposite neighboring stations Aᵢ₋₁ and Aᵢ₊₁ along the closed loop topology. The polarization states and P⁽²⁾ᵢ per station (generated by the generator 18B) satisfy an orthogonality condition as follows: \vec{E_{ι}⁽¹⁾} ⊥ \vec{E_{ι}⁽²⁾} to prevent interference between the transceivers of the same station, and \vec{E_{ι}⁽¹⁾} and \vec{E_{ι}⁽²⁾} are perpendicular to directions of propagation (unit vectors \vec{u_{ι-1}} and \vec{u_{ι}}) towards the preceding and successive stations, respectively. This will be described more specifically further below. It should be understood that direction of propagation is defined by the directionality of a respective signaling unit (e.g. antenna). In this regards, it is understood that \vec{E_{ι}⁽²⁾} and \vec{E_{ι+1}⁽¹⁾} both designating the polarization of the electromagnetic signals propagating between transceivers stations Aᵢ and Aᵢ₊₁ and therefore \vec{E_{ι}⁽²⁾}=\vec{E_{ι+1}⁽¹⁾}.

The polarization map data may be stored in the memory 16. Data indicative of the assigned polarization vectors \vec{E_{ι}⁽¹⁾} and \vec{E_{ι}⁽²⁾} is transmitted to each of the transceiver stations for managing/controlling the operation of the stations.

More specifically, the data processor 18 includes an analyzer module 18A and a polarization map generator module 18B. The analyzer module (software and/or hardware) 18A is adapted to analyze the arrangement map data. This analysis includes the following:

For each pair of transceivers of neighboring stations communicating with one another along the closed loop topology (keeping in mind that there are two “oppositely” operating transceivers at each station, as described above), unit vector \vec{u_{ι}} is identified, which is indicative of signaling direction between the corresponding pair of transceivers, i.e. T⁽²⁾ᵢ and T⁽¹⁾ᵢ₊₁. Then, as will be described more specifically further below, an endomorphism relation is determined which is based on the orthogonal polarization condition and is defined by the unit vectors \vec{u_{ι}} of each of the stations with respect to the neighboring stations along the closed loop topology starting from an arbitrarily selected station i=1, termed here “first station”. The endomorphism relation is processed to determine a corresponding eigenvector indicative of a first polarization vector for signal transmission between the first station and its neighboring station along the closed loop. The polarization map generator 18B applies further processing to the “first” polarization vector and the orthogonal polarization condition and successively determines polarization vectors for each of the transceiver stations.

As also shown in FIG. 1, the central system 10 may also include a map controller 19. The latter is configured and operable for controlling the arrangement map data and upon identifying a dynamic mode of the communication network, i.e. a change in position of at least one of the transceiver stations (e.g. in case the station is moving) or a change in the communication order along the closed loop, operating the processor utility 18 for updating the polarization map data. Such update may be performed in real time and the transceiver stations (their polarization utilities) are operated accordingly. The map controller 19 may identify the change in the location/order data received from the transceiver station(s) and operate the arrangement map generator 22 to update the unit vectors in the arrangement map data, or may receive the updated arrangement map data from the external generator.

Reference is made to FIG. 3 exemplifying arrangement of n points A₁, . . . Aₙ in a closed loop topology communication network 20. As shown, each of the unit vectors \vec{u₁}, \vec{u₂}, . . . , \vec{uₙ} describes a signaling direction (propagation direction) from the point to its next neighboring point along the closed loop. The orthogonal condition signifies that each polarization vector \vec{E_{ι}} is to be orthogonal to the precedent polarization vector \vec{E_{ι-1}} and the unit vector \vec{u_{ι}}. As shown in the figure, in the closed loop topology network, the polarization vector \vec{E₁} should be orthogonal to \vec{Eₙ} and \vec{u₁}, namely \vec{E₁}∥\vec{Eₙ}×\vec{u₁}, and also \vec{E₁} ⊥ \vec{E₂}.

Accordingly, the direction of the polarization vector \vec{E_{ι}} for use in communicating between a certain transceiver station Aᵢ and the successive station A₍ᵢ₊₁₎ along the closed loop, can be expressed in terms of the polarization vector \vec{E_{ι-1}} of the communication between station Aᵢ and the preceding transceiver station A₍ᵢ₋₁₎ and the unit vector \vec{u_{ι}} directed from the station Aᵢ to the successive transceiver station A₍ᵢ₊₁₎ as follows:

\vec{E_{ι}}∥Eᵢ₋₁×\vec{u_{ι}}\vec{} (1)

Successively working out this orthogonality condition along the n stations yields:

\vec{E₁}∥\vec{Eₙ}×\vec{u₁}

\vec{E₂}∥\vec{E₁}×\vec{u₂}∥(\vec{Eₙ}×\vec{u₁})×\vec{u₂}

\vec{Eₙ₋₁}∥\vec{Eₙ₋₂}×\vec{uₙ₋₁}∥((\vec{Eₙ}×\vec{u₁})× . . . ×\vec{uₙ₋₂})×\vec{uₙ₋₁} (2)

In the closed loop topology network, orthogonality condition should also be satisfied between polarization vectors \vec{Eₙ₋₁} and \vec{Eₙ}, as follows:

\vec{Eₙ}∥\vec{Eₙ₋₁}×\vec{uₙ}∥((\vec{Eₙ}×\vec{u₁})× . . . ×\vec{uₙ₋₁})×\vec{uₙ} (3)

This gives the following relation expressed in terms of unit vectors {\vec{u_{ι}}} indicative of the stations' arrangement as follows:

\vec{Eₙ}∥(((\vec{Eₙ}×\vec{u₁})×\vec{u₂})× . . . ×\vec{uₙ₋₁})×\vec{uₙ} (4)

The above relation (4) can be written using endomorphism operator. Defining n vectorial planes {\vec{P_{ι}}} orthogonal to the units vectors {\vec{u_{ι}}} (vectorial plane P₁ orthogonal to unit vector \vec{u₁}, P₂ orthogonal to \vec{u₂}, . . . , Pₙ orthogonal to \vec{uₙ}), the following n endomorphisms can be defined (for simplicity of notation, let us consider P₀=Pₙ):

φᵢ: Pᵢ₋₁→Pᵢ

\vec{x} [symbol] \vec{x}×\vec{u_{ι}}

Then, the endomorphism operator φ for the closed loop topology of the transceiver stations can be defined in Pₙ as:

φ=φₙφₙ₋₁ . . . φ₁.

Accordingly, the above condition (4) can be written using endomorphism operator φ as follows:

\vec{Eₙ}∥φ(\vec{Eₙ}) (5)

The polarization vector \vec{Eₙ} satisfying this condition (4) is found as eigenvector of the operator φ. Therefore, the analyzer 18A operates to search for an eigenvector for the endomorphism φ.

The above endomorphism relation based on the orthogonality condition and defined by the arrangement map (location of transceivers and unit vectors), can be used to enable single-channel communication using polarization diversity.

Once using the endomorphism relation (4; 5) for determining the polarization vector \vec{Eₙ} for communication between arbitrarily selected station Aₙ with the successive station A₁ (considering stations A₁, . . . Aₙ), the polarization vectors for the other stations are determined by successively applying the orthogonality condition (1) as shown in (2).

Given n transceiver stations (also referred to herein as nodes/points) A₁, A₂, . . . , Aₙ, communicating in a closed loop topology ordered from 1 to n, the following unit vectors are defined:

$$\vec{{u}_{1}} = \frac{\vec{{A}_{1} {A}_{2}}}{‖ \vec{{A}_{1} {A}_{2}} ‖} , \vec{{u}_{2}} = \frac{\vec{{A}_{2} {A}_{3}}}{‖ \vec{{A}_{2} {A}_{3}} ‖} , … , \vec{{u}_{n}} = \frac{\vec{{A}_{n} {A}_{1}}}{‖ \vec{{A}_{n} {A}_{1}} ‖} \qquad ( 6 )$$

Here, \vec{A₁A₂} is the vector between points A₁ and A₂.

Thus, the analyzer 18A may be configured and operable to define the unit vectors {\vec{u_{ι}}} according to any suitable closed loop topology of the network and use the unit vectors {\vec{u_{ι}}} of (6) to define the endomorphism relation (4).

Then the analyzer 18A may be configured and operable for finding the polarization vector \vec{Eₙ} being eigenvector of the endomorphism operator φ (the polarization \vec{Eₙ} between points Aₙ and A₁), and using polarization vector \vec{Eₙ} to compute the rest of the polarization vectors {\vec{E₁} . . . \vec{Eₙ₋₁}} which yields the polarization vectors {\vec{E₁} . . . \vec{Eₙ}} for communication signals along the closed loop topology (wherein \vec{E_{ι}} is the polarization of the for communication signals between stations Aᵢ and A₍ᵢ₊₁₎) while satisfying the condition that each polarization is orthogonal to the previous one and to the unit vector of propagation direction.

As indicated above the analyzer 18A operates to search for an eigenvector for the endomorphism φ. This may be performed for example by exploiting the fact that the eigenvalues of endomorphism φ in a vectorial plane are the solutions of the equation:

X²−tr(φ)X+det(φ)=0 (7)

where tr(φ) and det(φ) are the trace and the determinant of φ, respectively.

This equation has solutions if the following condition is satisfied:

tr(φ)²−4det(φ)≥0 (8)

Accordingly, the analyzer 18A may be configured and operable for determining eigenvector for the endomorphism φ (if such exists) utilizing any suitable technique for finding eigenvectors, for instance by defining the endomorphism operator φ using the unit vectors {\vec{u_{ι}}} and solving equation (7) for the operator φ.

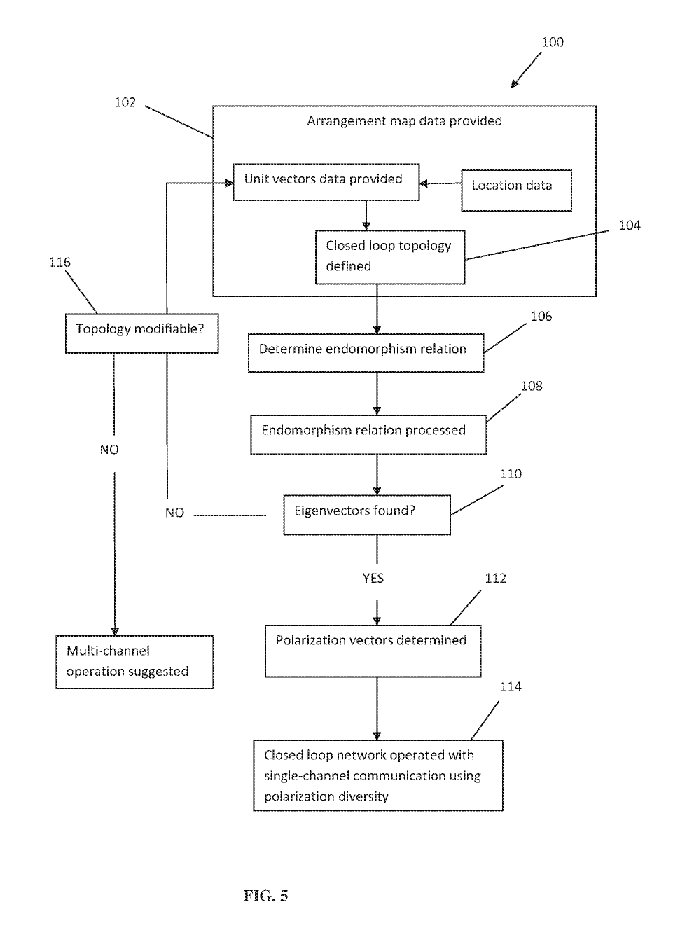

With reference to FIG. 4, for each vectorial plane Pᵢ, two vectors \vec{v_{ι}} and \vec{w_{ι}} are defined fulfilling the following conditions:
\vec{v_{ι}} is in the map including Aᵢ, Aᵢ₊₁ and Aᵢ₊₂ (for simplicity of notation, let us consider Aₙ₊₁=A₁ and Aₙ₊₂=A₂);
(\vec{u_{ι}}, \vec{v_{ι}}, \vec{w_{ι}}) is a direct orthonormal basis of the space.

Let us also define two vectors \vec{v′_{ι}} and \vec{w′_{ι}} in vectorial plane Pᵢ fulfilling the following conditions:
\vec{w′_{ι}}=\vec{w_{ι-1}} (for simplicity of notation, let consider \vec{w₀}=\vec{wₙ}).
(\vec{u_{ι}}, \vec{v′_{ι}}, \vec{w′_{ι}}) is a direct orthonormal basis of the space.

For each vectorial plane Pᵢ, two orthonormal basis Bᵢ=(\vec{v_{ι}}, \vec{w_{ι}}) and B′ᵢ=(\vec{v′_{ι}}, \vec{w′_{ι}}) are defined. Since (\vec{u_{ι}}, \vec{v_{ι}}, \vec{w_{ι}}) and (\vec{u_{ι}}, \vec{v′_{ι}}, \vec{w′_{ι}}) are both direct orthonormal basis, the change of basis matrix from Bᵢ to B′ᵢ is a rotation matrix:

$${R}_{i} = ( \begin{matrix}cos {α}_{i} & - sin {α}_{i} \\ sin {α}_{i} & cos {α}_{i}\end{matrix} )$$

Let us define the angle θᵢ=∠Aᵢ₋₁AᵢAᵢ₊₁

Since \vec{v_{ι-1}}×\vec{u_{ι}}=cos θᵢ\vec{w′_{ι}} and \vec{w_{ι-1}}×\vec{u_{ι}}=\vec{v′_{ι}}, the matrix of φᵢ with respect to the basis Bᵢ₋₁ and B′ᵢ is:

$${M}_{i} = ( \begin{matrix}0 & 1 \\ cos {θ}_{i} & 0\end{matrix} )$$

Therefore, the matrix of φ in orthonormal basis Bₙ is:

M=RₙMRₙ₋₁Mₙ₋₁ . . . R₂M₂R₁M₁ (9)

The solution to the presented problem takes into account two situations, depending on whether all the points are in the same plane or not.

If all the points are in the same plane, then orthonormal basis Bᵢ=B′ᵢ for all i, and the rotation matrices equal the identity matrix. Equation (9) becomes:

M=MₙMₙ₋₁ . . . M₂M₁ (10)

If N is an even number, equation (7) gives:

$$M = ( \begin{matrix}cos {θ}_{1} cos {θ}_{3} … cos {θ}_{n - 1} & 0 \\ 0 & cos {θ}_{2} cos {θ}_{4} … cos {θ}_{n}\end{matrix} )$$

In this case, the eigenvectors are \vec{vₙ} and \vec{wₙ}. This matches the intuitive solution of choosing polarization in the plane containing all the points and orthogonal to this plane, alternately. In addition, in the particular case where cos θ₁ cos θ₃ . . . cos θₙ₋₁=cos θ₂ cos θ₄ . . . cos θₙ, then φ is a homothety. Any vector is an eigenvector and the first polarization can be chosen arbitrarily.

If N is an odd number, equation (9) gives:

$$M = ( \begin{matrix}0 & cos {θ}_{2} cos {θ}_{4} … cos {θ}_{n - 1} \\ cos {θ}_{1} cos {θ}_{3} … cos {θ}_{n} & 0\end{matrix} )$$

Then, tr(φ)=tr(M)=0, and det(φ)=det(M)=−cos θ₁ cos θ₂ . . . cos θₙ

Equation (7) becomes:

X²−cos θ₁ cos θ₂ . . . cos θₙ=0

This equation has a solution if the following relation is satisfied:

cos θ₁ cos θ₂ . . . cos θₙ≥0,

which means that it has a solution if the number or obtuse angles in the polygon is even.

Since the total number of angles in the polygon is odd, a necessary and sufficient condition could be determined. The equation has a solution if the number of acute angles in the polygon is odd. The eigenvectors can be easily calculated:

$$\vec{{E}_{n}} = λ ( \begin{matrix}\sqrt{cos {θ}_{2} cos {θ}_{4} … cos {θ}_{n - 1}} \pm \\ \sqrt{cos {θ}_{1} cos {θ}_{3} … cos {θ}_{n}}\end{matrix} ) , λ ∈$$

In the general case, in which the points are not assumed to be in the same plane, the calculation of M from equation (9) is more complicated and tr(φ) cannot be calculated easily. However, since the determinants of rotation matrices Rᵢ equal to 1, det(φ) can be calculated:

det(φ)=det(M)=det(M₁)det(M) . . . det(Mₙ)=(−1)ⁿ cos θ₁ cos θ₂ . . . cos θₙ

Therefore, a sufficient, though not necessary, condition for equation (7) having a solution can be expressed: if the number of acute angles in the polygon is odd, then det(φ)≤0 and equation (7) has a solution.

In the particular case n=4, even when the four points are not on the same plane, it can be proved that equation (7) always has a solution, as follows.

Without loss of generality, it may be assumed that the points have the following coordinates:

$${A}_{1} ( \begin{matrix}1 \\ 0 \\ 0\end{matrix} ) , {A}_{2} ( \begin{matrix}a \\ b \\ 0\end{matrix} ) , {A}_{3} ( \begin{matrix}c \\ d \\ e\end{matrix} ) , {A}_{4} ( \begin{matrix}0 \\ 0 \\ 0\end{matrix} )$$

According to the notations above,

$$\vec{{u}_{4}} = ( \begin{matrix}1 \\ 0 \\ 0\end{matrix} ) , \vec{{v}_{4}} = ( \begin{matrix}0 \\ 1 \\ 0\end{matrix} ) , \vec{{w}_{4}} = ( \begin{matrix}0 \\ 0 \\ 1\end{matrix} )$$

and after calculation:

$$( ( ( \vec{{v}_{4}} \times \vec{{A}_{1} {A}_{2}} ) \times \vec{{A}_{2} {A}_{3}} ) \times \vec{{A}_{3} {A}_{4}} ) \times \vec{{A}_{4} {A}_{1}} = ( a - 1 ) ( \begin{matrix}0 \\ d ( b - d ) + c ( a - c ) \\ e ( b - d )\end{matrix} )$$

$$( ( ( \vec{{w}_{4}} \times \vec{{A}_{1} {A}_{2}} ) \times \vec{{A}_{2} {A}_{3}} ) \times \vec{{A}_{3} {A}_{4}} ) \times \vec{{A}_{4} {A}_{1}} = ( \begin{matrix}0 \\ ( 1 - a ) ed + bec \\ ( 1 - a ) ( {e}^{2} + c ( c - a ) ) + bc ( b - d )\end{matrix} )$$

Therefore,

$$M = \frac{1}{‖ \vec{{A}_{1} {A}_{2}} ‖ ‖ \vec{{A}_{2} {A}_{3}} ‖ ‖ \vec{{A}_{3} {A}_{4}} ‖ ‖ \vec{{A}_{4} {A}_{1}} ‖} S$$

with

$$S = ( \begin{matrix}( a - 1 ) ( d ( b - d ) + c ( a - c ) ) & ( 1 - a ) ed + bec \\ ( a - 1 ) e ( b - d ) & ( 1 - a ) ( {e}^{2} + c ( c - a ) ) + bc ( b - d )\end{matrix} )$$

tr(S)²−4det(S)=((a−1)(d(b−d)+e²)−bc(b−d))²+4e²(a−1)(b−d)((1−a)d+bc)

tr(S)²−4det(S)=((a−1)(d(b−d)−e²)−bc(b−d))²≥0

Therefore, S has eigenvectors and φ has eigenvectors. This demonstrates that it is possible to use one single frequency (channel) in any ring topology network including four points.

The results are summarized in the table below:

| | Odd number of points | Even number of points | 4 points |
|---|---|---|---|
| Points in the | Solution if and only if | There is solution | There is a |
| same plane | there is odd number of | | solution |
| | acute angles | | |

| | |
|---|---|
| Points not in | Solution if number of acute angles is odd |
| the same plane | |

Reference is made to FIG. 5 showing a flow diagram 100 of an example of the technique of the present invention.

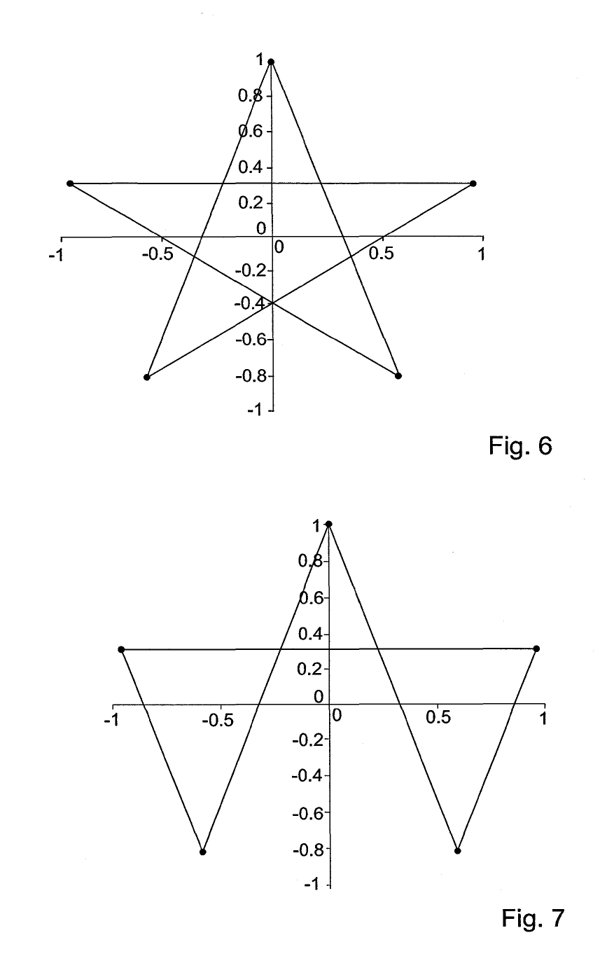

The arrangement map data is provided (step 102) as described above. The arrangement map data includes location data about of the transceiver stations to be involved in the closed loop topology network, and given/possibly adjustable directionalities of the transceivers defining the initial given/possibly adjustable order of communication between the stations, defining an initial given/possibly adjustable closed loop topology (step 104), e.g. the topology of FIG. 3. Then, based on the unit vector of the initial topology, the above described analyzing and processing are applied to the arrangement map data to determine endomorphism relation (step 106), process the endomorphism relation (step 108), and identify whether eigenvectors for the endomorphism relation can be found (step 110). In case the eigenvectors for the endomorphism relation are found, the polarization vectors are determined, i.e. the polarization map (step 112), and the transceivers of the stations are operated accordingly (step 114) for single-channel communication. If no eigenvectors for the endomorphism relation are found, then the system operates to check whether the topology can be modified (step 116), i.e. whether the directionality of the one or more of the transceivers may be varied to appropriately adjust the unit vector(s) in accordance with different topology, such as that of FIG. 6 or 7, described below.

In this connection, it should be noted that permitted/possible topology should satisfy also a signal-to-noise condition. A change of topology may imply higher distances, and therefore higher emitted powers, which may offset the gain in bandwidth. Therefore, since the ultimate goal is to optimize spectral efficiency (i.e. bit rate per unit of bandwidth), the modified topology is considered as relevant only if spectral efficiency is improved.

The case may be such that topology cannot be modified as it should be maintained (in a specific application) or modification does not improve spectral efficiency. Alternatively, the case may be such modification of the topology (by repeating the above steps) shows that no modification provides for finding the eigenvectors for the endomorphism relation. In such cases, the system may generate output indicative of no single-channel communication is possible and a multi-channel communication should be used.

The following are three examples of how the results described above can be applied for managing the closed loop single-channel communication network.

### EXAMPLE 1

### There is a Right Angle in the Ring (Namely there are Two Successive Unit Vectors Orthogonal to One Another)

If there is a right angle in the ring, e.g. in Aᵢ, then det(Mᵢ)=0 and therefore det(φ)=0. Equation (7) has a solution. The solution may be obtained by choosing \vec{E_{ι}}=\vec{u_{ι-1}} and then applying successively φᵢ₊₁, . . . , φₙ, φ₁, . . . , φᵢ₋₁. The last vector is in vectorial plane Pᵢ₋₁ and therefore is orthogonal to \vec{E_{ι}}.

### EXAMPLE 2

### A Ring of Three Points (Triangle Topology)

As a result of the condition given above in the instance that the number of points is odd, equation (7) has a solution if the three angles of the triangle are acute.

### EXAMPLE 3

### Regular Pentagon

In a convex regular pentagon, all angles are obtuse. The condition given with regards to odd number of points is not fulfilled and polarization diversity does not enable the use of one single frequency over the ring.

However, if the pentagon vertices are connected according to a “sheriff star”, as shown in FIG. 6, then all the angles are acute and the use of one single frequency is possible. Another solution also enables the use of one single frequency, as shown in FIG. 7, being a pentagon with three long sides and two short sides.

Thus, given n points (transceivers) A₁, A₂, . . . , Aₙ, the appropriate polarizations can be calculated as follows:
1) Define n vectors

$$\vec{{u}_{1}} = \frac{\vec{{A}_{1} {A}_{2}}}{‖ \vec{{A}_{1} {A}_{2}} ‖} , \vec{{u}_{2}} = \frac{\vec{{A}_{2} {A}_{3}}}{‖ \vec{{A}_{2} {A}_{3}} ‖} , … \vec{{u}_{n}} = \frac{\vec{{A}_{n} {A}_{1}}}{‖ \vec{{A}_{n} {A}_{1}} ‖}$$

2) Define two vectors \vec{vₙ} and \vec{wₙ} fulfilling the conditions:
   \vec{vₙ} is in the map including Aₙ, A₁ and A₂;
   (\vec{uₙ}, \vec{vₙ}, \vec{wₙ}) is a direct orthonormal basis of the space.
3) Express the vectors ((\vec{vₙ}×\vec{u₁})× . . . ×\vec{uₙ₋₁})×\vec{uₙ} and ((\vec{wₙ}×\vec{u₁})× . . . ×un−1×un in the basis Bn=vn,wn
4) Express the matrix M of endomorphism φ: \vec{x} [symbol] ((\vec{x}×\vec{u₁})× . . . ×\vec{uₙ₋₁})×\vec{uₙ}
5) Search the eigenvectors of φ.

If endomorphism φ has no eigenvector, no polarization will enable the network coverage by one single channel. However, in this case, the points A₁, A₂, . . . , Aₙ can be permutated and the processing restarts from step 1) above, following the example of the regular pentagon as described above.

If endomorphism φ has an eigenvector \vec{Eₙ}, this eigenvector can be taken as the polarization direction between transceivers Aₙ and A₁. For any i, 1≤i≤n−1, the eigenvector:

\vec{E_{ι}}=((\vec{Eₙ}×\vec{u₁})× . . . ×\vec{u_{ι-1}})×\vec{u_{ι}}

gives the polarization between Aᵢ and Aᵢ₊₁.

Thus, turning back to FIG. 1, the analyzer 18A at the central system 10 receives the arrangement map data related to the closed loop topology network including the number of transceiver station and the unit vector for an arbitrary selected station, and determines the corresponding polarization vector with respect to the next neighboring station. The polarization map generator 18B uses this polarization vector and successively determines polarization vectors for each of the other stations. Then, the central system provides respective control signals to each station.

1-25. (canceled)

26. A communication network for wireless communication, the communication network comprising:
a plurality of transceiver stations for wireless communication therebetween in a closed loop topology, wherein each of the plurality of transceiver stations includes a pair of transceivers for directional communication with a pair of transceivers at opposite neighboring transceiver stations in the closed loop topology;
wherein the communication network is configured and operable to perform a single-channel communication between the plurality of transceiver stations with polarization diversity such that polarization state for transmission between each one of the plurality of transceiver stations and the neighboring station thereof is orthogonal to a polarization state for transmission between said neighboring station and a successive neighboring station and is orthogonal to a unit vector of direction of propagation between said one of the plurality of transceiver stations and said neighboring station.

27. The communication network of claim 26, wherein the polarization state for transmission between each one of the plurality of transceiver stations and the neighboring stations thereof is assigned based on an arrangement map including at least location data having locations of the plurality of transceiver stations defining the closed loop topology.

28. The communication network of claim 26, wherein each of the plurality of transceiver stations includes a polarization utility adapted to controllably modify polarization vectors of signals transceived by each transceiver of said pair of transceivers.

29. The communication network of claim 28, wherein each of the plurality of transceiver stations is configured and operable to be responsive to control data from a management system via a network, said control data including data being indicative of assigned polarization states for transmission between said transceiver and two neighboring stations along said closed loop.

30. An electromagnetic transceiver station configured for communication with opposite neighboring electromagnetic transceiver stations thereof in a communication network having a closed loop topology, the electromagnetic transceiver station comprising:
two transceivers for communication with said opposite neighboring electromagnetic transceiver stations respectively, said two transceivers having polarization states assigned for signal-channel communication with said two neighboring stations such that polarization state for transmission between said transceiver station and the neighboring station is orthogonal to polarization state for transmission between said neighboring station and a successive neighboring station.

31. The electromagnetic transceiver station of claim 30, further comprising a polarization utility adapted to controllably modify polarization vectors of signals transceived by each of said two transceivers in accordance with polarization states assigned for said two transceivers.

32. The electromagnetic transceiver station of claim 31, configured and operable to be responsive to control data from a management system via a network, said control data including data being indicative of the assigned polarization states for transmission between said transceiver and two neighboring stations along said closed loop topology of the communication network.

33. The electromagnetic transceiver station of claim 30, wherein the assigned polarization state is based on an arrangement map including at least location data including locations of the transceiver stations defining the closed loop topology of the communication network.

34. A management system for managing operation of a plurality of electromagnetic transceiver stations forming a wireless electromagnetic closed loop communication network, the management system being configured as a computer system being part of or connected to a network for data communication with said plurality of the transceiver stations via said network, the management system comprising:
a data processor utility that is adapted to carry out the following:
receive and process data indicative of an arrangement map of said plurality of the electromagnetic transceiver stations, the data indicative of the arrangement map including at least location data having locations of the plurality of electromagnetic transceiver stations defining at least one closed loop topology; and
generate data indicative of a polarization map for said communication network for communication between the plurality of electromagnetic transceiver stations using a single frequency channel, said data indicative of the polarization map including data indicative of assigned polarization states for transmission between each two neighboring stations along said closed loop satisfying an orthogonal polarization condition, such that the polarization states for transmission between each one of the plurality of electromagnetic transceiver stations and the neighboring station thereof is orthogonal to the polarization state for transmission between said neighboring station and a successive neighboring station and is orthogonal to a unit vector of direction of propagation between said one of the plurality of electromagnetic transceiver stations and said neighboring station.

35. The management system of claim 34, wherein said data indicative of the arrangement map includes data indicative of unit vectors of lines connecting each two neighboring stations defining said at least one closed loop topology.

36. The management system of claim 34, wherein the data processor utility includes an arrangement map generator for utilizing the location data and determining unit vectors of lines connecting each two neighboring stations defining said at least one closed loop topology.

37. The management system of claim 34, wherein the data processor utility includes:
an analyzer module adapted to carry out the following:
(i) analyze the data indicative of the arrangement map and utilize data indicative of unit vectors of lines connecting each two neighboring stations defining said at least one closed loop topology, to determine, for each station, the unit vector indicative of direction to the neighboring station thereof along said at least one closed loop topology, and determine an endomorphism relation based on the orthogonal polarization condition and the unit vectors of each of the plurality of electromagnetic transceiver stations with respect to the neighboring stations along said closed loop topology starting from an arbitrarily selected first one of the plurality of electromagnetic transceiver stations; and
(ii) process the endomorphism relation to determine a corresponding eigenvector indicative of a first polarization vector for signal transmission between said selected first station and the neighboring station thereof along the loop.

38. The management system of claim 37, wherein the data processor utility includes a polarization map generator adapted to utilize said first polarization vector and successively determine polarization vector for each of the stations.

39. The management system of claim 37, wherein said analyzer module is adapted for generating a control signal upon identifying that the endomorphism relation has no eigenvector.

40. The management system of claim 37, wherein said analyzer module is configured and operable to carry out the following: upon identifying that the endomorphism relation has no eigenvector, modifying the arrangement map data by varying the unit vectors thereby modifying the closed loop topology, and repeating the acts (i) and (ii) for each of the modified closed loop topologies.

41. The management system of claim 40, wherein said analyzer module is adapted for generating a control signal upon identifying that the endomorphism relation has no eigenvector.

42. The management system of 40, wherein said analyzer module utilizes the location data and directionality of operation of the plurality of electromagnetic transceiver stations to determine one or more possible closed loop topologies satisfying required spectral efficiency for the network operation.

43. The management system of claim 37, wherein the data processor utility includes a map controller and is adapted for updating the polarization map in response to data indicative of change in location of at least one of the transceiver stations.

44. A method for managing operation of a plurality of electromagnetic transceiver stations in a wireless electromagnetic communication network of a closed loop topology, the method comprising:
providing data indicative of an arrangement map of said plurality of the electromagnetic transceiver stations, wherein said data indicative of the arrangement map includes at least location data indicative of locations of the stations defining at least one closed loop topology; and
processing said data indicative of the arrangement map and generating a polarization map for communication between said plurality of electromagnetic transceiver stations using a single frequency channel including data indicative of assigned polarization states for transmission between each two neighboring stations along said closed loop, thereby providing single-channel communication between plurality of electromagnetic transceiver stations in the closed loop topology network, wherein said processing includes:
determining polarization vectors satisfying an orthogonal polarization condition, such that the polarization vector for transmission between each one of the plurality of electromagnetic transceiver stations and the neighboring station thereof is orthogonal to the polarization vector for transmission between said neighboring station and a successive neighboring station and is orthogonal to the unit vector of direction of propagation between said one of the stations and said neighboring station.

45. The method of claim 44, wherein said providing of the data indicative of the arrangement map includes analyzing the location data defining said at least one closed loop topology and determining data indicative of unit vectors of lines connecting each two neighboring stations for said at least one closed loop topology.

46. The method of claim 44, wherein said processing of the arrangement map data includes:
(i) for each of the plurality of electromagnetic transceiver stations, utilizing unit vector indicative of the direction to the neighboring station thereof along said at least one closed loop topology, and determining an endomorphism relation based on the orthogonal polarization condition and the unit vectors of each of the stations with respect to the neighboring stations along said closed loop topology starting from an arbitrarily selected first one of the stations; and
(ii) processing the endomorphism relation to determine a corresponding eigenvector indicative of a first polarization vector for signal transmission between said selected first station and its neighboring station along the loop.

47. The method of claim 46, wherein said generating of the polarization map includes utilizing said first polarization vector and successively determining polarization vector for each of the stations.

48. The method of claim 46, wherein said processing of the arrangement map data includes carrying out one of the following: (a) generating a control signal upon identifying that the endomorphism relation has no eigenvector; or (b) upon identifying that the endomorphism relation has no eigenvector, modifying the arrangement map data by varying the unit vectors thereby modifying the closed loop topology, and repeating the acts (i) and (ii) for each of the modified closed loop topologies.

49. The method of claim 48, wherein said processing includes utilizing the location data and directionality of operation of the plurality of electromagnetic transceiver stations and determining one or more possible closed loop topologies satisfying required spectral efficiency.

50. The method of claim 44, further comprising updating the polarization map upon identifying change in location of at least one the transceiver stations.

51. The method of claim 50, further comprising monitoring the location data, and upon identifying said change and updating the polarization map, communicating with one or more of the plurality of electromagnetic transceiver stations for real time managing polarization vectors for operation of said one or more of the plurality of electromagnetic transceiver stations.
